(19) United States
(12) Patent Application Publication
(10) Pub. No.: US 2011/0151426 A1
(43) Pub. Date: Jun. 23, 2011

(54) LEARNING TOOL

(76) Inventor: Stefan OBERG, Stockholm (SE)

(21) Appl. No.: 12/976,529

(22) Filed: Dec. 22, 2010

Related U.S. Application Data
(60) Provisional application No. 61/289,064, filed on Dec. 22, 2009.

(51) Int. Cl. G09B 3/00

(52) U.S. Cl. 434/350

(57) ABSTRACT

A system for learning and method thereof are described. The system comprises a processor; a memory storing a set of instructions for execution by the processor, the set of instructions comprising a learning tool, the learning tool comprises a course management module arranged to generate a course responsive to user input, a test management module arranged to test a user based on at least a portion of the course, the test management module also arranged to filter the portions of the course presented to the user based on a user-supplied rehearsal status value, and a content management module arranged to export at least a portion of the course to one or more formats for user review.

### RELATED APPLICATIONS

The present application is based on, and claims priority from, U.S. Provisional Application No. 61/289,064, filed Dec. 22, 2009, the disclosure of which is hereby incorporated by reference herein in its entirety.

### BACKGROUND

Prior computer-based learning methods have not included the capability for a user to include rich multimedia capabilities on user-created content.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a high-level functional block diagram of a computer network usable in conjunction with an embodiment;

FIG. 2 is a high-level functional block diagram of a learning tool according to an embodiment;

FIG. 3 is a high-level functional process flow of a slide creation method according to an embodiment;

FIG. 4 is a high-level functional process flow of a template creation method according to an embodiment;

FIG. 5 is a high-level functional process flow of a learn method according to an embodiment;

FIG. 6 is a high-level functional process flow of a test creation method according to an embodiment;

FIG. 7 is a high-level functional process flow of a test administration method according to an embodiment;

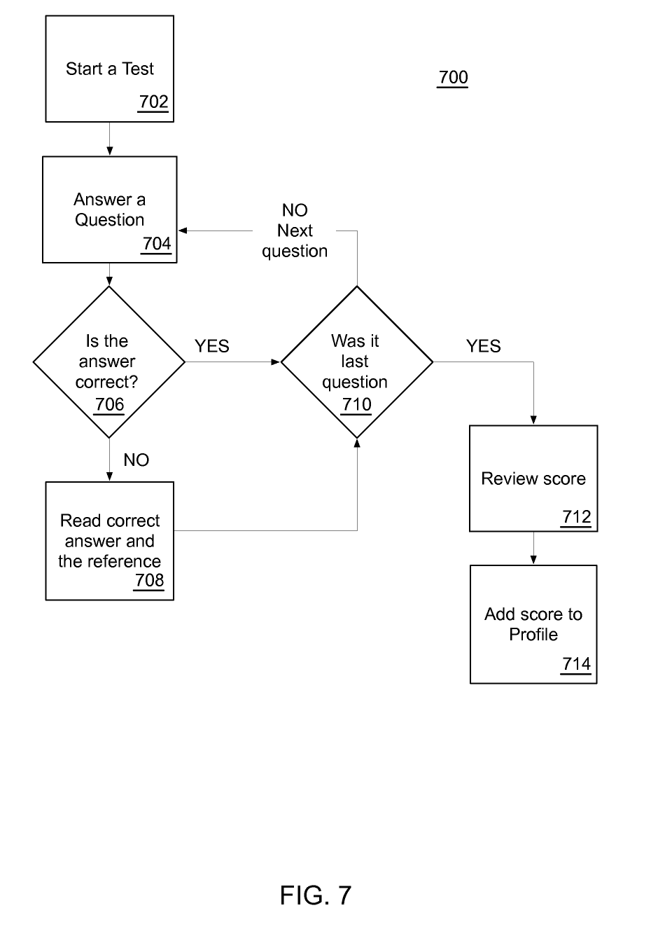

FIG. 8 is a schematic view of a slide of a selected course in accordance with at least a portion of a rehearsal mode according to an embodiment; and

FIG. 9 is a schematic view of a rehearsal mode filter window according to an embodiment.

### DETAILED DESCRIPTION

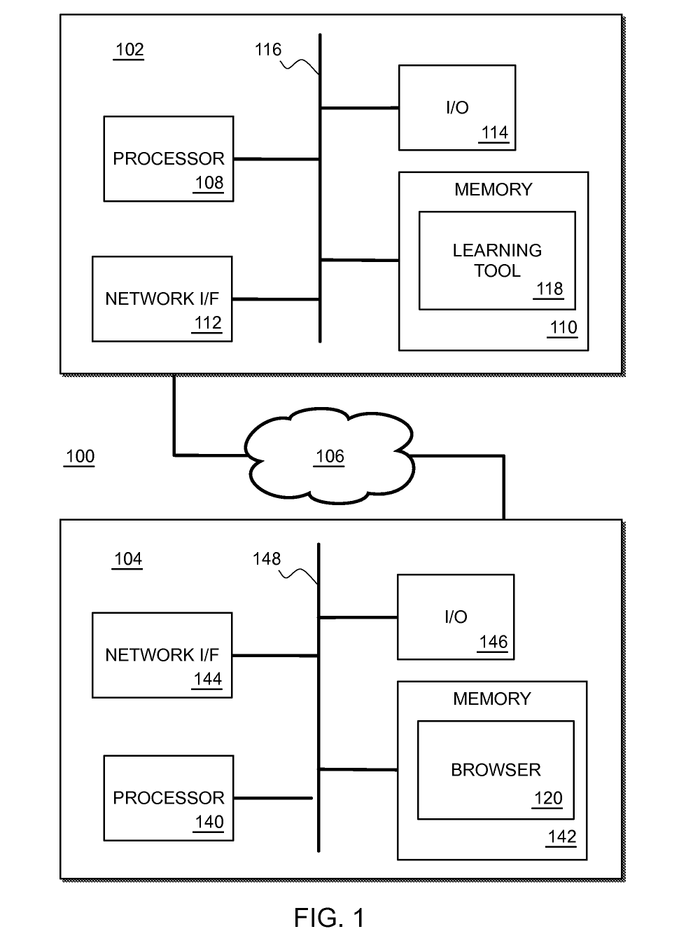

FIG. 1 is a high-level functional block diagram of a computer network 100 usable in conjunction with an embodiment and comprising a first or server computer system 102, e.g., a web server, communicatively coupled with a second or client computer system 104, e.g., a personal computer of a user, via a network 106 such as the Internet.

In at least some embodiments, first and second computer systems 102, 104 may be other than server and client, respectively. In at least some embodiments, first and second computer systems 102, 104 are processor or controller-based devices and may range from a handheld or smaller processing device to a server or larger processing device. In at least some embodiments, first and second computer systems 102, 104 may be replaced by a single computer system for executing the described functionality.

In at least some embodiments, network 106 is a wireless and/or wired network connecting first and second computer systems 102, 104.

First computer system 102 comprises a processor 108 (alternatively referred to as a processing or controller-based device), a memory 110, a network interface (I/F) 112, and an input/output device 114 communicatively coupled via a bus 116 or other interconnection communication mechanism.

Memory 110 (also referred to as a computer-readable medium) may comprise a random access memory (RAM) or other dynamic storage device, coupled to the bus 116 for storing data and/or instructions to be executed by processor 108 such a learning tool 118 according to an embodiment. Memory 110 also may be used for storing temporary variables or other intermediate information during execution of instructions to be executed by processor 108. Memory 110 may also comprise a read only memory (ROM) or other static storage device coupled to the bus 116 for storing static information and instructions for the processor 108.

Network I/F 112 comprises a mechanism for connecting to a network. In at least some embodiments, computer system 102 comprises more than a single network interface. In at least some embodiments, network I/F 112 may comprise a wired and/or wireless connection mechanism. In at least some embodiments, computer system 102 connects with second computer system 104 via bus 116 and/or I/O 114.

A storage device, such as a magnetic disk, optical disk, or electromagnetic disk, may also be provided and coupled to the bus 116 for storing data and/or instructions.

Learning tool 118 comprises a set of executable instructions which, when executed by processor 108, cause the processor to execute functionalities according to an embodiment. In at least some embodiments, learning tool 118 execution by processor 108 causes the display of a user interface to a user of either first computer system 102 or second computer system 104 either via I/O device 114 or network I/F 112.

I/O device 114 may comprise an input device, an output device and/or a combined input/output device for enabling user interaction. An input device may comprise, for example, a keyboard, keypad, mouse, trackball, trackpad, and/or cursor direction keys for communicating information and commands to processor 108. An output device may comprise, for example, a display, a printer, a voice synthesizer, etc. for communicating information to a user. In at least some embodiments, I/O device 114 may comprise a serial and/or parallel connection mechanism for enabling the transfer of one or more of files and/or commands. In at least some embodiments, I/O device 114 is an optional component of computer system 102.

Second computer system 104, usable in conjunction with an embodiment of first computer system 102, comprises a processor 140 (alternatively referred to as a controller or processing device), a memory 142, a network interface (I/F) 144, and an input/output device 146 communicatively coupled via a bus 148 or other interconnection communication mechanism.

Memory 142 (also referred to as a computer-readable medium) may comprise a random access memory (RAM) or other dynamic storage device, coupled to the bus 148 for storing data and/or instructions to be executed by processor 140. Memory 142 also may be used for storing temporary variables or other intermediate information during execution of instructions to be executed by processor 140. Memory 142 may also comprise a read only memory (ROM) or other static storage device coupled to the bus 148 for storing static information and instructions for the processor 140. Memory stores a set of executable instructions comprising a browser 150.

Browser 150 comprises a set of instructions which, when executed by processor 140 cause the second computer system 104 to operate in response to receipt of one or more commands received, for example, via network I/F 144 or I/O device 146. In at least one embodiment, browser 150 operates responsive to receipt of a signal from first computer system 102.

Network I/F 144 comprises a mechanism for connecting to a network and/or first computer system 102. In at least some embodiments, computer system 104 comprises more than a single network interface. In at least some embodiments, network I/F 144 may comprise a wired and/or wireless connection mechanism. In at least some embodiments, computer system 104 connects with first computer system 102 via bus 148 and/or I/O 146. In at least some embodiments, network I/F 144 may be connected to a packet-based interconnected network of devices such as an internet or the worldwide packet-switched network known as the Internet.

A storage device, such as a magnetic disk, optical disk, or electromagnetic disk, may also be provided and coupled to the bus 148 for storing data and/or instructions.

I/O device 146 may comprise an input device, an output device and/or a combined input/output device for enabling user interaction. An input device may comprise, for example, a keyboard, keypad, mouse, trackball, trackpad, and/or cursor direction keys for communicating information and commands to processor 140. An output device may comprise, for example, a display, a printer, a voice synthesizer, etc. for communicating information to a user. In at least some embodiments, I/O device 146 may comprise a serial and/or parallel connection mechanism for enabling the transfer of one or more of files and/or commands. In at least some embodiments, I/O device 146 is an optional component of second computer system 104.

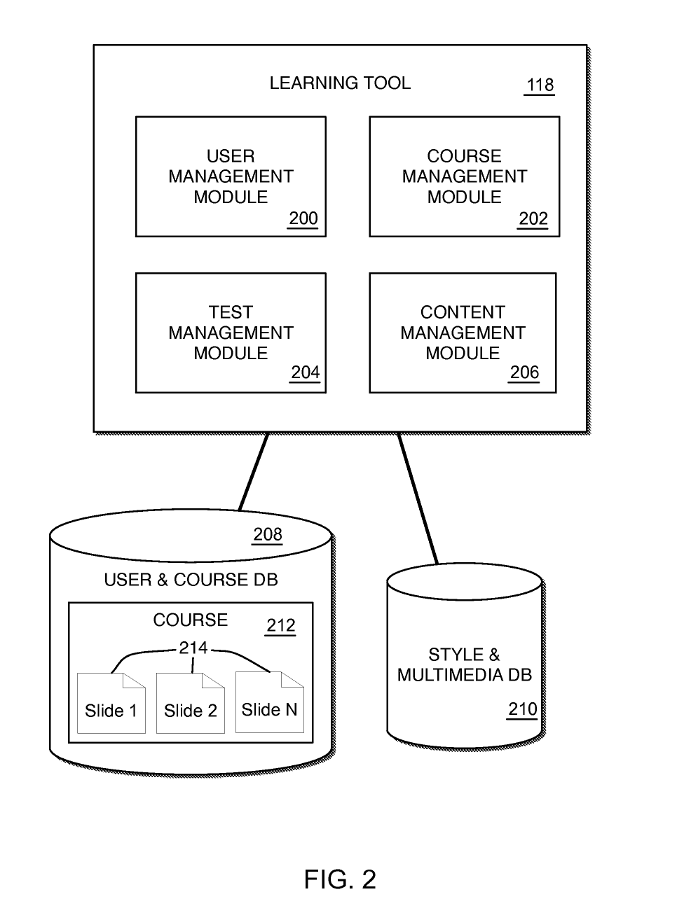

FIG. 2 is a high-level functional block diagram of a portion of memory 110 comprising learning tool 118 according to an embodiment. Learning tool 118 comprises a user management module 200, a course management module 202, a test management module 204, and a content management module 206. Memory 110 also comprises a user and course database 208 and a style and multimedia database 210.

In at least some embodiments, user and course database 208 and style and multimedia database 210 may be combined into a single database without departing from the spirit and scope of the present disclosed embodiments. In at least some embodiments, greater or fewer number of databases may be used in conjunction with learning tool 118.

User and course database 208 stores a course 212 which comprises one or more slides 214. In at least some embodiments, course 212 comprises a collection of information to be learned by a user. The information is stored in connection with one or more slides 214 on which the information is arranged. In at least some embodiments, each slide comprises a set of information to be related to the user. In at least some embodiments, a slide may comprise textual information, audio information, and/or video or graphic information. Graphic information may include photographs, drawings, or other images.

User management module 200 comprises a set of instructions which, when executed and/or interpreted by processor 108, cause the processor to manage information related to users of learning tool 118. For example, user management module 200 monitors and/or maintains user authorization and/or authentication in addition to permission-related information. User management module 200 is also responsible for maintaining and updating biographic information of a user. Additionally, in at least some embodiments, user management module 200 maintains demographic user information.

User management module 200, during execution by processor 108, accesses and updates information stored in the user and course database 208. In at least some embodiments, user management module 200 stores one or more of biographical information about the user, authentication information about the user, information identifying courses authored by the user, information identifying courses taken by the user, friends of the user, groups to which the user belongs, points obtained by the user, course test results of the user, social network URLs of the user, status updates of the user, and course progress information of the user.

The user can register to the website or log in using external credentials from social networking websites, e.g., Facebook. In at least some embodiments, registration is free of charge and in others a fee is charged. Registered users access features such as rehearsal functionality and test functionality, challenge functionality, etc. In at least some embodiments, registered user create courses, bookmark particular slides from existing courses, etc.

Course management module 208 comprises a set of instructions which, when executed and/or interpreted by processor 108, cause the processor to manage information related to courses created and stored in user and course database 208.

Course management module 202, during execution by processor 108, accesses and updates information stored in the user and course database 208 related to courses.

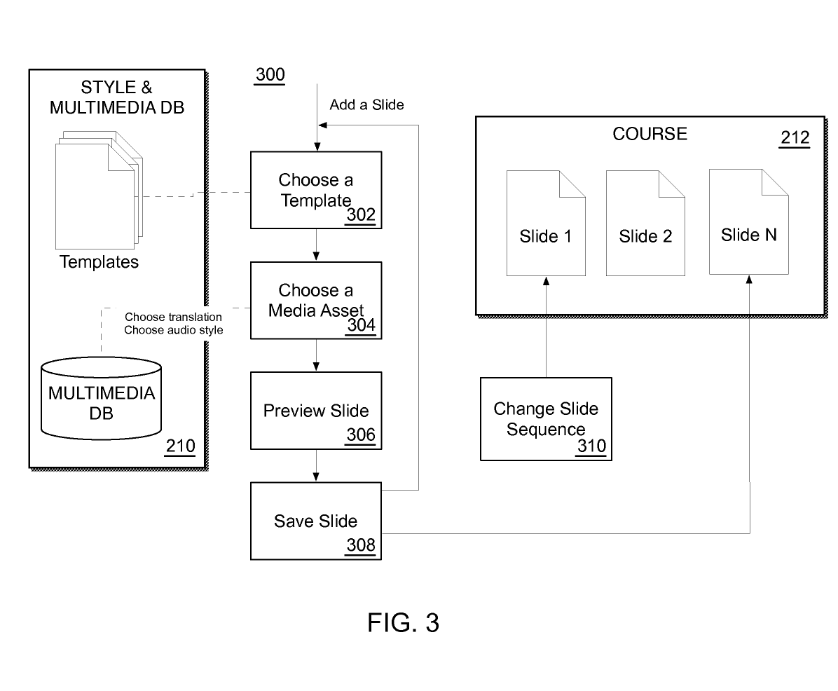

FIG. 3 is a high-level functional process flow of at least a portion of a course creation method 300 according to an embodiment. The process flow begins at functionality 302 during execution of which the user chooses a template for a slide in course 212 based on one or more templates stored in style and multimedia database 210. The flow then proceeds to functionality 304.

In at least one alternative embodiment, prior to the user selecting a template, the user selects and uploads an existing presentation file, e.g., a powerpoint or other presentation formatted file, to be used for the course. In accordance with the scenario, the existing presentation file is imported and each slide of the existing file is translated into a slide in the course 212. After importation of the existing presentation file content, additional content may be added to the slide at the user's direction.

During execution of functionality 304, the user selects one or more media assets from, e.g. a multimedia database stored in, style and multimedia database 210. In at least some embodiments, one or more media assets are uploaded from a user designated memory storage, e.g., a local hard disk of the user or a user-controlled network accessible storage. In at least some embodiments, during execution of functionality 304, the user may also choose for the course one or more language translations which may be stored in database 210. The flow then proceeds to functionality 306.

During execution of functionality 306, a preview of a slide according to the previously selected template and/or media asset from functionalities 302 and 304 is cause to be displayed to the user. Given that the user approves the previewed slide, the flow of control then proceeds to functionality 308 wherein the user selections for the course are saved to memory. If the user does not approve of the previewed slide, the flow of control then returns to either of functionalities 302 or 304 for revision of the selections.

In at least some embodiments, functionality 306 is optional and a preview of a slide may not be generated prior to continuing the process flow.

If the user desires to add another slide to course 212, the flow of control returns to functionality 302 and the user makes template and media asset selections for the added slide. If the user desires to modify the sequence of slides comprising course 212, the flow of control proceeds to functionality 310 and the user is able to change the order in which sides are presented.

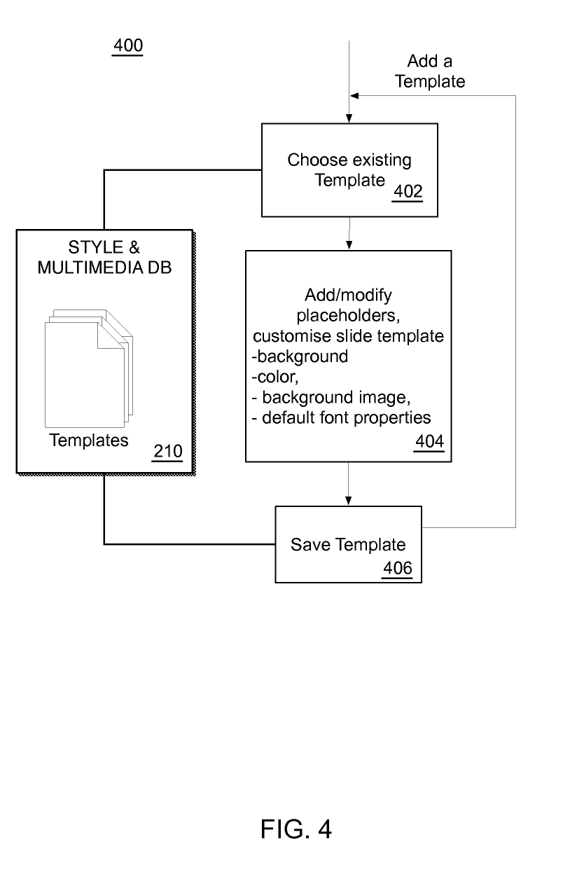

FIG. 4 is a high-level functional process flow of at least a portion of a template creation method 400 according to an embodiment. The process flow begins at functionality 402 during execution of which the user chooses a template for a slide in course 212 based on one or more templates stored in style and multimedia database 210. In at least some embodiments, the functionality 402 is optional and a new template may be created by the user without selecting from database 210.

In at least some embodiments, a user may select a blank template on which to add content for a slide of a course.

The flow then proceeds to functionality 304 wherein the user is able to add and/or modify placeholder elements on the template slide for a given course 212. Additionally, the user is able to modify slide background parameters such as color, background image, etc. In at least some embodiments, the user is able to modify default font properties for textual elements on the template.

The flow then proceeds to functionality 406 wherein the created and/or modified template is stored in database 210.

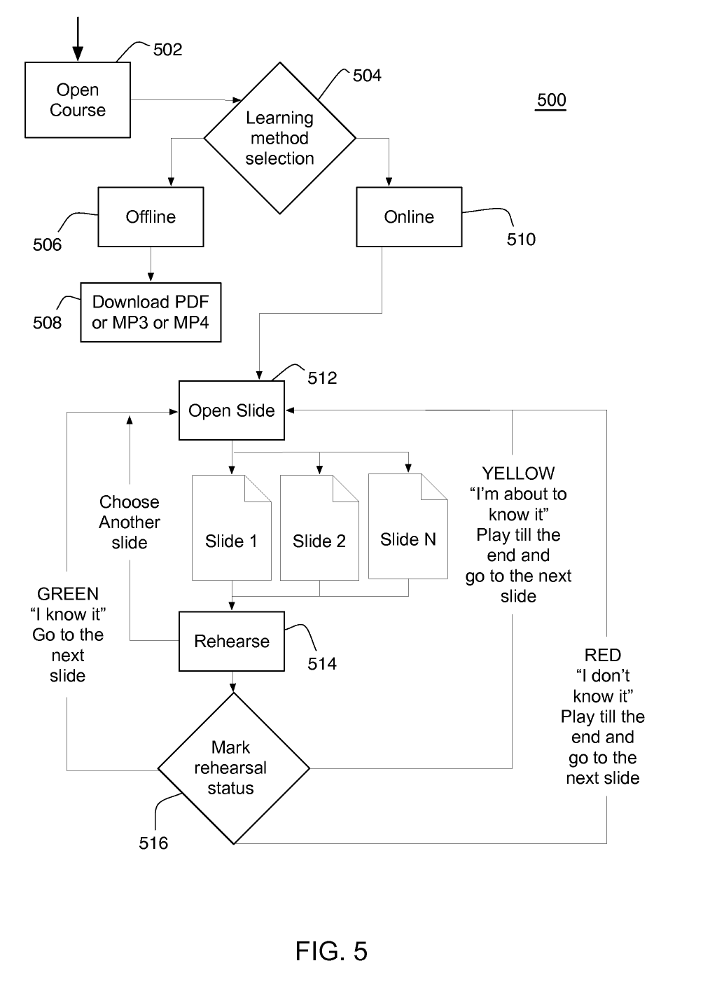

FIG. 5 is a high-level functional process flow of at least a portion of a learn content method 500 according to an embodiment. The process flow begins at functionality 502 during execution of which the user selects a course 212 from user and course database 208 having content which the user desires to learn. During execution of functionality 502, one or more slides 214 of the course 212 may be loaded into memory 110 from the database 208. In at least some embodiments, the entire course 212 is loaded from database 208 into memory 110.

After the course is selected and opened, the process flow proceeds to functionality 504 wherein execution by the processor causes the user to be prompted, e.g., by the display of a prompt on a monitor or other display such as within browser 120 at second computer system 104, to select whether an online or off-line method of learning is desired by the user. Responsive to receipt of user input via browser 120 and I/O device 146 which indicates an off-line learning mode is requested, the process flow proceeds to functionality 506.

Execution of functionality 506 by processor 108 causes the processor to generate one or more file formats for off-line use by the user. In at least some embodiments, the one or more formats comprise at least a text-based format, an audio format, a video format, an audio/video format, or a combination thereof. In at least some embodiments, the text format may comprise a text file or a portable document format file; the audio format may comprise a WAV file or an MP3 file; the video format may comprise an MP4 file.

Returning to functionality 504, responsive to receipt of user input which indicates an online learning mode is requested, the process flow proceeds to functionality 510. In at least some embodiments, a rehearsal player functionality is initiated upon opening of a first slide of a course.

The process flow proceeds to functionality 512 wherein a slide 214 of the selected course 212 is obtained from memory 110 for display to the user. In at least some embodiments, a particular slide 214 in a course 212 may be opened responsive to user input via browser 120. For example, the user may wish to start at a particular slide in a slide sequence of a course. In at least some other embodiments, a particular slide 214 in a course 212 may be opened responsive to information retrieved by learn content method 500 from user and course database 208, e.g., last slide viewed by a particular user captured by user management module 200.

The process flow proceeds to functionality 514 wherein the selected slide is rehearsed or displayed to the user, for example for the user to memorize the slide content. Responsive to receipt of user input, the flow proceeds to either displaying another slide (e.g., by return to functionality 512) or functionality 516 wherein the user assigns a rehearsal status to the slide.

Responsive to receipt of a rehearsal status from the user, execution of functionality 514 stores the rehearsal status value in user and course database 208 in conjunction with user, course, and slide information. The rehearsal status comprises three possible values including green, yellow, and red. In at least some embodiments, the user assigns the rehearsal status prior to completion of execution of the entirety of the slide content. In at least some embodiments, there may be greater or fewer number of possible values for rehearsal status.

A green value assigned to the rehearsal status of a slide 214 indicates that the user believes that they know the content of the slide and the next slide in sequence is requested to be displayed. A yellow value assigned to the rehearsal status of the slide indicates that the user believes that they have a level of confidence in their knowledge of the content less than a green value and completed viewing of the slide content is requested. Assignment of a yellow value to the slide by the user causes the learn content method to execute the entirety of the content of the slide prior to advancing to the next slide in sequence by returning to functionality 512.

A red value assigned to the rehearsal status of the slide indicates that the user believes that they do not know the slide content and additional review (e.g., in the form of additional viewing of the slide) is necessary. Assignment of a red value to the slide by the user causes the learn content method to execute the entirety of the slide content prior to advancing to the next slide in sequence by returning to functionality 512. A user may use the rehearsal status value to differentiate between slides based on a differing level of knowledge or user comfort in knowledge of the slide content.

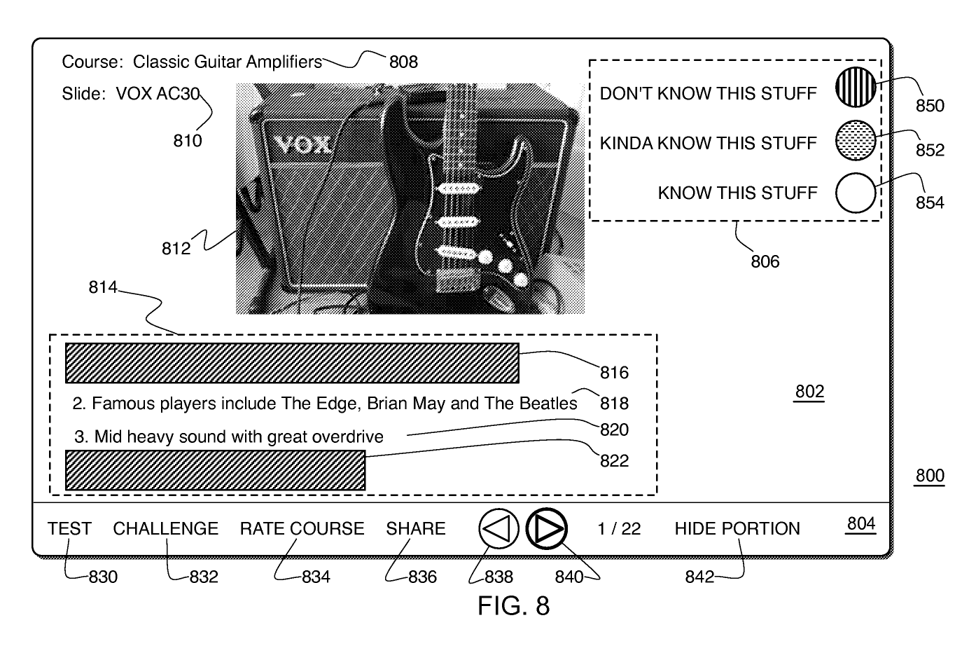

FIG. 8 is a schematic view of a slide 800 of a selected course 212 in accordance with at least a portion of a rehearsal mode. For example, in at least some embodiments, the rehearsal mode comprises at least a portion of learn content method 500 during which the user reviews one or more slides to learn the slide content. In at least some embodiments, the user attempts to memorize one or more facts presented on the slide 214 content. In at least one embodiment, the rehearsal mode comprises a portion of the functionality within functionalities 512 through 516 of FIG. 5.

Slide 800 comprises a content region 802, a control region 804, and a rehearsal status region 806. Content region 802 comprises information to be learned by the user. Control region 804 comprises one or more controls, e.g., buttons, hyperlinks, or other input generating mechanisms, for the user to manipulate for controlling interaction with slide 800. Rehearsal status region 806 comprises a status indicator and/or a status input control for user manipulation to set a rehearsal status value with respect to slide 800. In at least some embodiments, there are greater or fewer number and/or type of regions on slide 800 and, in some embodiments, one or more of the regions may be combined.

Content region 802 comprises a course title indicator 808, a slide identifier field 810, media content 812 in the form of an image, and a list region 814 listing pieces of information for memorization by a user 816-822. As depicted, two items of information in list region 814 are blocked from view, i.e., are hidden, by an obstructing graphic element, e.g., an opaque box. By hiding one or more pieces of information in list region 814, the user's attention to be focused more on unblocked pieces of information. In at least some embodiments, the hidden or blocked from view items of information are user-determined.

In at least some embodiments, the obstructing graphic element may be positioned and/or size responsive to user input.

Control region 804 comprises a plurality of controls for manipulation by the user including a test control 830, a challenge control 832, a rating control 834, a share control 836, a back control 838, a forward control 840, and a hide control 842. Test control 830 causes execution of a test related to the course of which slide 800 is a part. Manipulation of challenge control 832 causes execution of a challenge method by which the user can challenge one or more other users to a test related to the content of the particular course identified by course identifier 808. Manipulation of rating control 834 causes the display of a rating input control enabling the user to rate the particular course being rehearsed. Manipulation of share control 836 causes execution of a sharing method by which the user can share a link to the particular course with one or more other users.

Manipulation of back control 838 and forward control 840 enables the user to move backward and/or forward, respectively, through the slides of the particular course. Manipulation of hide control 842 generates an obstructing graphic element on the slide which may be positioned and/or resized at the user direction to cover one or more items of information in list region 814. In at least some embodiments, further manipulation of hide control 842 combined with selection of the obstructing graphic element may be used by a user to cause the removal of the graphic element from slide 800.

In at least some embodiments, greater or fewer numbers of controls are comprised in control region 804.

Rehearsal status region 806 comprises three status setting inputs corresponding to the reversal status values described above: a red status 850 corresponding to a lack of knowledge of the slide content; a yellow status 852 corresponding to some knowledge of the slide content; and a green status 854 corresponding to knowledge of the slide content. In at least some embodiments green status 854 corresponds to user knowledge of all slide content. Each of the status setting inputs 850, 852, 854 comprise user-manipulable inputs, i.e., the user may select from one of the three status settings to specify the users level of comfort with the slide content.

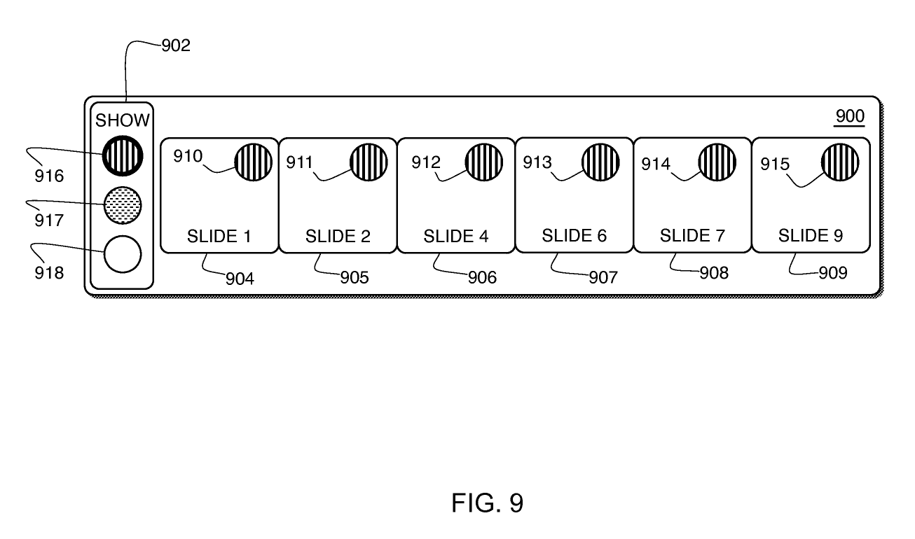

FIG. 9 is a schematic view of a rehearsal mode filter window 900 which may be used in conjunction with a course to selectively narrow the slides to be presented during a rehearsal mode. Filter window 900 comprises a filter input 902 to receive a user determined request to view one or more slides having a particular rehearsal status value. Filter window 900 also comprises a small or thumbnail view of a set of slides, e.g., 904-909, corresponding to the selected rehearsal status value of filter input 902. Each slide 904-909 also comprises a rehearsal status indicator 910-915 corresponding to a rehearsal status values set by the user during a rehearsal mode. In at least some embodiments, slides 904-909 do not comprise the rehearsal status indicator explicitly.

Filter input 902 comprises a set of three buttons corresponding to the reversal status values available to the user: red status 916, yellow status 917, and green status 918. Manipulation of one of the three buttons 916-918 causes a filtered subset of the slides of the course to be displayed in filter window 900. As depicted, red status 916 is selected and each of the slides in filter window 900 have a rehearsal status value of red. The user is able to manipulate, for example by double-clicking, a slide thumbnail in the filter window 900 in order to view a full-size version of the selected slide and perform additional rehearsal and/or review of the slide content.

Returning to FIG. 2, test management module 204 comprises a set of instructions which, when executed and/or interpreted by processor 108, cause the processor to manage information related to one or more tests based on one or more courses 212 stored in user and course database 208. Test management module 204, during execution by processor 108, accesses and updates test-related information stored in the user and course database 208.

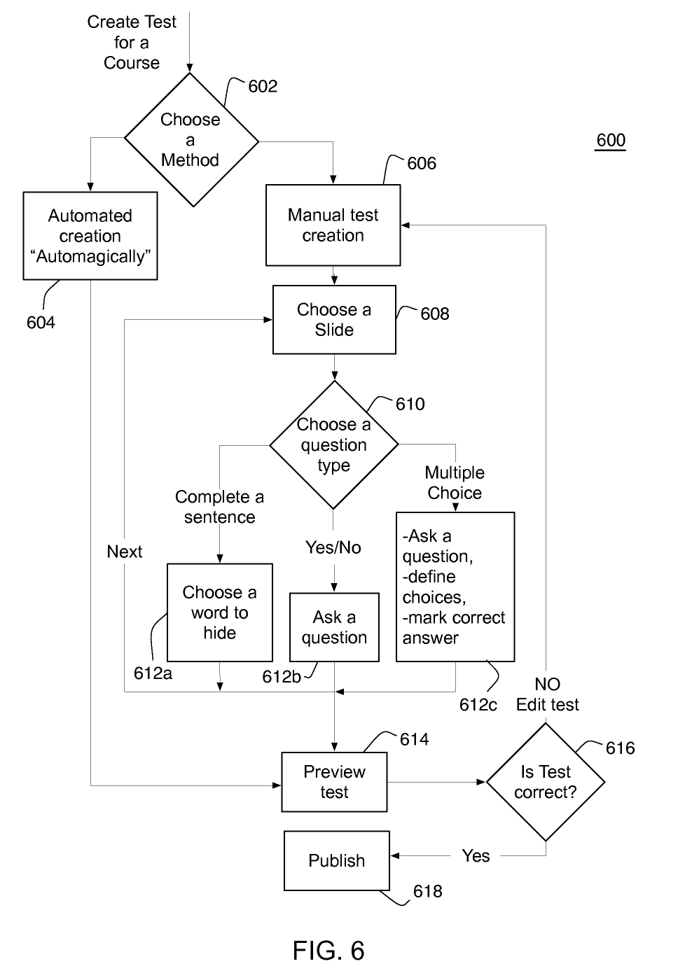

FIG. 6 is a high-level functional process flow of at least a portion of a test creation method 600 according to an embodiment. The process flow begins at functionality 602 during execution of which the user chooses a test creation method. In response to receipt of user input indicating automated test creation, the flow of control proceeds to functionality 604 wherein a test based on slide content of a user selected course 212 is automatically created. In at least some embodiments, the created test is stored in user and course database 208. After execution of functionality 604 and automated creation of test, the flow of control proceeds to functionality 614 wherein the user is able to preview the created test.

In at least one embodiment, the automatic creation of a test comprises the generation of questions corresponding to slide content without user input. For example, in at least one embodiment, automatic creation comprises the generation of four random questions, e.g., two questions directed to sentence completion corresponding to functionality 612a and two questions directed to multiple choice corresponding to functionality 612c. One or more of the generated questions is, for example randomly, selected for use in an automatically created test.

In at least some embodiments, after execution of functionality 604 and automated creation of the test, the flow of control proceeds directly to functionality 618 and the course is published.

Returning to functionality 602, in response to receipt of user input indicating manual test creation, the flow of control proceeds to functionality 606 wherein manual test creation begins. During functionality 606, a test building mode is entered by the process flow during which the user builds a test based on the course content. The flow of control proceeds to functionality 608.

During execution of functionality 608, the user supplies an input to select a particular slide 214 of a particular course 212 from which to create a test question. After selection of the particular slide 214, the flow of control proceeds to functionality 610 wherein the user provides input to select a particular question type. In at least some embodiments, there are three question types available for user selection: sentence completion (indicated by functionality 612A), yes/no or true/false (indicated by functionality 612b), or multiple choice (indicated by functionality 612c).

In at least some embodiments, an automated process may be executed to automatically generate questions for a given slide similar to functionality 604.

In at least some embodiments, there may be greater or fewer number of question types available for user selection.

During execution of functionality 612a, the user selects a particular word in a sentence displayed on the slide to be hidden from view of a test taker. During execution of functionality 612b, the user inputs text comprising a question based on the selected particular slide content in which the question is answerable using either a yes/no or a true/false answer. During execution of functionality 612c, the user inputs the text of a question having one or more correct answers and the user also inputs the possible answers including an indication of the correct answer. After execution of functionality 612a, 612b, or 612c, the flow of control may return to functionality 608 or proceed to functionality 614 responses to receipt of user input.

During execution of functionality 614, a preview display of the created test is displayed to the user for review and the flow of control proceeds to functionality 616. During execution of functionality 616, the test creation method 600 receives input from the user indicating whether the preview test is correct or not. If the user input indicates that the preview test is incorrect, the flow of control returns to functionality 606 for editing of one or more test questions. If the user input indicates that the preview test is correct, the flow of control proceeds to functionality 618 and the test is published.

After a test is created and published, the test is available for users to access and execute. A listing of the course corresponding to the created test includes a hyperlink to the created test.

In at least some embodiments, multiple output formats are available for use by the user. In addition, the user is not restricted to selecting a single output format for the course material. In a given scenario, a user may choose to receive course material in numerous, and possibly overlapping, ways. In at least some embodiments, the user receives: a) course slides via a browser and the Internet, b) course textual material via a really simply syndication (RSS) feed via a browser on a computer and/or a mobile device such as a telephone, c) audio translations of the textual material or audio material via a browser and/or a mobile device, d) audio material via an audio feed service such as a podcast. In at least some embodiments, first computer system 102 may initiate a telephone call to the user, based on user biographic information stored in user and course database 210, in order to read (for example via a text to speech translation software) the textual material to the user.

In at least some embodiments, exported audio files for output formats may comprise, for example, MP3 format files based on user-provided content and/or multimedia database 210 content. In at least some embodiments, exported video files for output formats may comprise, for example, MP4 format files based on a video snapshot captured during presentation of a portion of video content from the slides and/or sound files of a course. In at least some embodiments, exported graphic files for output formats may comprise, for example PDF format files based on a snapshot captured during presentation of a portion of slide content of a course.

In at least some embodiments, user and course database 210 stores rehearsal status values for slides of a course reviewed by the user in conjunction with other user information. In accordance with at least some embodiments, the system combines the stored user information, e.g., email address, text message address, phone number, instant messaging account information, social networking site information, etc. with the course, slide, and rehearsal status value information to generate one or more feeds of course material for review by the user in one or more communication mediums. In an embodiment, the system transmits one or more portions of slide content to the user using one or more of the indicated user information contact mechanisms. Additionally, the system may use one or more of the user information contact mechanisms in order to provide additional content distribution avenues to the user, e.g., the system may send a text message to the user which contains a URL for the user to visit to connect, register, and receive one or more podcasts of the slide content material, the system may send an email to the user which contains a hyperlink for an RSS feed to which the user may subscribe to receive slide content, etc.

In one embodiment, a geography student learning “Capitals of the World” takes the “Capitals of the World” course. The student prepares by using the rehearsal player via the website. In order to reinforce the student's learning while away from the computer, the student prints off PDF-based flash cards, i.e., simple printable documents that can be cut into palm sized cards. Each card comprises a slide image on the back and the slide text on the front from a particular user-selected course. Flash palm cards are a useful memorization tool enabling the student to quickly glance through the cards throughout the day to keep the facts close to mind. Additionally, the student downloads a compressed content package, e.g., comprising one or more MP3 files, for the course for use on a portable player, e.g., an iPod on the student's way to school. The content package contains all of the slides in a folder of separate audio files where each audio file contains the audio and image for one slide (the image are viewable on the iPod screen). The package also contains an audio playlist, e.g., iTunes playlist, file so the user can drag the audio files into iTunes and have them all grouped together in the course context, e.g., “Capitals of the World Playlist”. The audio files are playable on any audio player device, e.g., iPod, mp3 player, iPhone, Zune, many digital multimedia devices. The student uses the Flash cards whenever he has a break and is walking to the next class. The student plays the MP3's on his iPod on his way to and from school.

In one other embodiment, a bookstore manager wants to teach his staff the top ten bestsellers of all time. The bookstore manager creates a course which has ten slides with the book titles, author names, cover artwork and genre. Next to the main staff notice board in the store the manager puts up a digital picture frame and uses a USB memory stick to load the MP4 video file of the course onto the frame memory and sets the frame to play the course on a loop. Every time a staff member goes to enter their work hours on the notice board the staff member also receives a refresher on the bestsellers list contents.

In one other embodiment, an information technology (IT) student is preparing for a Microsoft Certification course. The IT student builds a memorization course with slides comprising the brands, names, model numbers and images of different network components. The student adds the RSS feed for the course to his RSS Feed Reader software (eg Bloglines) so he can have a quick look at the course slides every time he is checking his news feeds. The IT student also has a Wi-Fi or other network-enabled picture frame on the wall of his study (e.g., near the window). The student sets the frame software to pick up the course RSS feed and the slides rotate amongst the photos randomly. The student thereby learns while looking out the window.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A system for learning, comprising:
a processor;
a memory storing a set of instructions for execution by the processor, the set of instructions comprising a learning tool, the learning tool comprising:
a course management module arranged to generate a course responsive to user input;
a test management module arranged to test a user based on at least a portion of the course, the test management module also arranged to filter the portions of the course presented to the user based on a user-supplied rehearsal status value; and
a content management module arranged to export at least a portion of the course to one or more formats for user review.

2. The system as claimed in claim 1, further comprising a user management module arranged to control interaction between a user and the learning tool.

3. The system as claimed in claim 1, wherein the course comprises one or more multimedia elements.

4. The system as claimed in claim 3, wherein the one or more multimedia elements are user-selected.

5. The system as claimed in claim 1, wherein the content management module is arranged to export at least a portion of the course to one or more formats for user interaction.

6. The system as claimed in claim 1, wherein the content management module is arranged to automatically export the at least a portion of the course to two or more formats for user review.

7. The system as claimed in claim 1, wherein the two or more formats comprise two or more of an audio only format, an audio and video format, or a text-based format.

8. The system as claimed in claim 1, wherein the rehearsal status value is stored in a user and course database.

9. A method of learning comprising:
presenting a multimedia course to a user, the course comprising one or more slides having multimedia elements;
receiving, from the user, a rehearsal status value with respect to one or more slides; and
presenting at least a portion of the multimedia course to the user after filtering the slides of the course based on the received rehearsal status value to remove slides below a predetermined rehearsal status value.

10. The method as claimed in claim 9, wherein the presenting at least a portion comprises transmitting course content to the user.

11. The method as claimed in claim 10, wherein transmitting comprises transmitting one or more of a text message comprising a location reference to the content, an email message comprising a location reference to the content, an email message comprising the content to the user.

12. The method as claimed in claim 10, wherein transmitting comprises transmitting the content via an RSS feed to the user or via a podcast to the user.

13. The method as claimed in claim 9, wherein presenting comprises exporting the at least a portion of the course to two or more formats for user review.

14. The method as claimed in claim 13, wherein the two or more formats comprise two or more of an audio only format, an audio and video format, an audio and still image format or a text-based format.

15. A memory or a computer-readable medium storing instructions which, when executed by a processor, cause the processor to perform the method of claim 9.
